(19) United States
(12) Patent Application Publication
(10) Pub. No.: US 2007/0092135 A1
(43) Pub. Date: Apr. 26, 2007

(54) Method and device for colour calibrating a camera and/or a display device and for correcting colour defects from digital images

(75) Inventor: Petri Piirainen, Joensuu (FI)

Correspondence Address: HARRINGTON & SMITH, PC, 4 RESEARCH DRIVE, SHELTON, CT, 06484-6212, US

(73) Assignee: Softcolor Oy

(21) Appl. No.: 11/638,136

(22) Filed: Dec. 12, 2006

Related U.S. Application Data
(63) Continuation of application No. PCT/FI05/00278, filed on Jun. 14, 2005.

(30) Foreign Application Priority Data
Jun. 17, 2004 (FI) 20040834

(51) Int. Cl. G06K 9/00

(52) U.S. Cl. 382/167

(57) ABSTRACT

The present invention relates to a method for colour calibrating a camera and/or a display device and for correcting colour defects from digital images, in which method a digital image formed with a camera and/or a display device is adjusted by correcting colour defects of the digital image of the camera and/or the display device. Characteristic to the method in accordance with the invention is the fact that a digital image formed/produced with a camera and/or a display device is corrected by means of a database formed from the spectrum information of colour references. In addition, the objective of the invention is a device in accordance with the method in accordance with the invention.

This application is a continuation of International Patent Application No. PCT/FI2005/000278.

The present invention relates to a method for colour calibrating a camera and/or a display device and for correcting colour defects from digital images, in which method a digital image formed with a camera and/or a display device is adjusted by correcting colour values of the digital image of the camera and/or the display device. The invention also relates to a device for colour calibrating a camera and/or a display device and for correcting colour defects of a digital image, which device comprises equipment for adjusting the digital image formed with a camera and/or a display device for correcting colour values of the digital image of the camera and/or the display device.

### BACKGROUND OF THE INVENTION

Correcting colour defects of a camera or a display device is currently carried out on grounds of a colour presentation of three or four values in certain lighting situation or by means of general colour profiles. The white balance of a camera is adjusted while taking a picture with a camera. In addition, colour profiles are used, with which it is aimed to gain a uniform colour reproduction with the display device in certain colour temperature of lighting. The digital response of a camera and a display device is also adjusted by means of gamma correction. In addition, in colour correction also algorithms of hardware manufactures are employed which are based on white balancing or measuring of colour temperature. A display device is categorized by using colour spaces of three or four values (for example, RGB, Lab, RGBA, RGBE or XYZ) in certain lighting. After this, colours of a display device are aimed to be adjusted such that those values corresponding to a colour profile with deviation correspond as good as possible to the theoretical values. Usually a colour profile of a display device is adjusted such that with different devices as similar as possible colour reproduction is achieved. This is also the goal in sRGB technique i.e. to create a uniform colour model between, for example, a camera and a display device.

Currently known colour correction of three or four values in certain lighting does not take into account the change in lighting because in present methods, no information about lighting is added, but a colour correction is carried out directly on grounds of the image information created by a camera or a display device. In addition, a colour presentation of three or four values is relatively blurred as while adjusting it, only three or four values having influence on colour may be changed. Furthermore, using only colour profiles does not enable the correction of individual defects (connected with certain wavelengths) of a camera by means of calibration.

The objective of the invention is to provide a method and a device with which the earlier mentioned disadvantages connected with currently known methods of colour calibration and colour correction are eliminated. Especially, the objective of the invention is to provide a method for colour calibration and colour correction of a camera and/or a display device, which is more accurate than earlier, in which method changes in lighting may be taken into account and with which method individual defects of a camera and a display device may be corrected.

### DESCRIPTION OF THE INVENTION

In the method and the device in accordance with the invention colour calibration of a camera or a display device is first carried out. In this colour calibration, the colour presentation of colour references formed on grounds of spectrum information of colour references is calculated from the spectra of colour references and the spectrum of lighting by multiplying the spectra of colour references by the spectrum of lighting. In this way, the influence of lighting may be taken into account by means of a very simple calculation. The spectrum information of colour references and the spectrum information of lighting are either earlier known data saved in the database or data measured during calibration. Mere colour calibration is a sufficient measure in certain applications employed in conditions with static lighting e.g. distance medicine and endoscopy. While lighting changes the colour presentation of colour references formed of the spectrum information of colour references is calculated again by multiplying the spectra of colour references by the spectrum of changed lighting. The spectrum of changed lighting may either be measured at the picture-taking situation or collect the earlier defined data from a database. In this way colour correction may be carried out in various lighting conditions without having to measure the colour spectra formed from the colour references again or to collect from a database. This further makes it simpler and fastens the correction as well as makes it possible to form a real time image in spite of changing lighting conditions. Due to this, the calculation time necessary for the method may be kept very short, which makes it possible, for example, to form a real time video image in spite of relatively great frame rate. This enables the use of the method e.g. in demanding medical applications in which the frame rate usually has to be at least 30 images/s.

In an application of the method in accordance with the invention, the colour world of a digital image is corrected to correspond to lighting conditions or desired lighting condition by means of the spectrum information of lighting.

In an application of the method in accordance with the invention colour calibration of a digital camera is carried out by taking a picture of colour references under lighting condition, where the spectrum of lighting is known. The colour spectra of colour references have been measured or they are earlier known. Colour defects of a camera and a display device are found out by comparing the RGB-values of the digital response of the camera to the exact and right RGB-values of the colour references. The exact RGB-values are formed from the colour spectra of the colour references and the lighting spectrum. The method is not limited only to RGB-values but it may be applied to any colour spaces with three or more components. This colour calibration information enables the real-time colour correction corresponding to lighting. The same method is applied to display devices but the spectral response is measured from the display device. In calibrating a display device, the most exact result is gained by measuring the response with a wavelength detector of light.

In an application of the method in accordance with the invention colour calibration of a digital camera or a display device starts with measuring the spectrum of lighting or choosing the lighting spectrum from a database. By means of the lighting spectrum an exact and as right as possible colour world is generated, for example to the traditional RGB-colour space, under existing photographing circumstances. The final colour correction is carried out by editing the digital image data of the camera or the display device to correspond to the generated exact colour values. The colour defects found in the colour calibrating of the camera or the display device are taken into account in the generated colour space. The generated colour space is edited in accordance with the defects to correspond to the optimal situations. While needed, a digital image may be edited by means of the method to correspond to a different lighting circumstance, which may differ from lighting at the photographing moment, for example, a picture taken in incandescent lamp lighting may be changed to correspond to daylight circumstance.

In an application of the method in accordance with the invention the light spectrum, which is needed for colour calibrating and colour correction of a camera or a display device, is measured by means of a wave length detector of light, which may be integrated to a camera and/or a display device or connected fixed to a device or it may be used as an external component. Identifying of the spectrum of lighting in the device is carried out exactly, by measuring the wavelengths of light or the spectrum of lighting may be gathered from a database by means of some characteristics measured from lighting, for example, by means of peaks of the spectrum of lighting or by means of colour temperature of lighting. Deviation of lighting into wavelengths may be carried out, for example, by means of a grating or filters and the detection of different wavelengths, for example, with a line detector. Identifying of the spectrum of lighting may also be carried out on grounds of the content of the image data, in 10 which case certain characteristics are searched from the image data, by means of which the spectrum is found from the database.

In an application of the method and device in accordance with the invention, the colour spectra of colour references and the lighting spectrum are measured with a wavelength detector. The spectra of colour references are usually defined with an external device. While defining the lighting spectrum a wavelength detector may be a device outside the camera or a display device or it may be integrated to a camera or to a display device. The sensor of the camera itself may also be employed for defining wavelengths in some cases. The divining of light into spectrum in a wavelength detector may be realized, for example, by means of filters or gratings. For monitoring wavelengths themselves, for example, a line detector may be used. In this way, all wavelengths of the spectrum of light may be measured very precisely and reliably. Due to this, with calibrating and correcting it is possible to achieve an exact and reliable result as well as various colours of different cameras and display devices to correspond exactly to each other.

Most frequently RGB-colour presentations are calculated from the spectrum information of colour references. The RGB colour space is the most common colour presentation method currently used in cameras and display devices and therefore colour calibration and correction based on that are applicable for most currently used digital cameras and display devices. From RGB colour presentations of colour references formed of the spectrum information of colour references a system function of a camera and/or a display device is formed by subtracting or adding RGB colour values of RGB colour presentations formed of the spectrum information of colour references from RGB colour values of a camera and/or a display device. By means of the system function, the corrected RGB colour presentation of a camera and/or a display device is defined. In this way it is possible to define defects in RGB colour space of a camera and/or a display device such that a RGB table presentation may be formed from them, which table corresponds by form to the RGB table presentation formed by the camera and/or the display device, in which for every value 0-255 of colours R, G and B there is its own system function value. Due to this the method enables to correct individual device related defects in RGB colour presentation of a camera or display device exactly (in other words, even small deviations, which are in some of the values 0-255 of colours R, G or B). When lighting changes RGB colour presentations corresponding to the new lighting circumstance are calculated from the light spectrum and the spectra of colour references. By means of this information the system function, obtained as the result of calibration of the device is up-dated to correspond to lighting. Corrected RGB colour presentation of a camera and/or a display device is formed by adding the RGB colour values of the system function, up-dated on the grounds of the change in lighting to the RGB colour values of the RGB colour presentation of the camera and/or the display device. In this way, the correction of the RGB colour presentation of a camera and/or a display device may be carried out by a very simple calculation, in which case the colour correction is possible to make happen extremely fast and therefore easy to be realized in real time in practical applications.

### DESCRIPTION OF CLAIMS

Next, the invention will be explained in more detail with reference to the accompanying charts, in which,

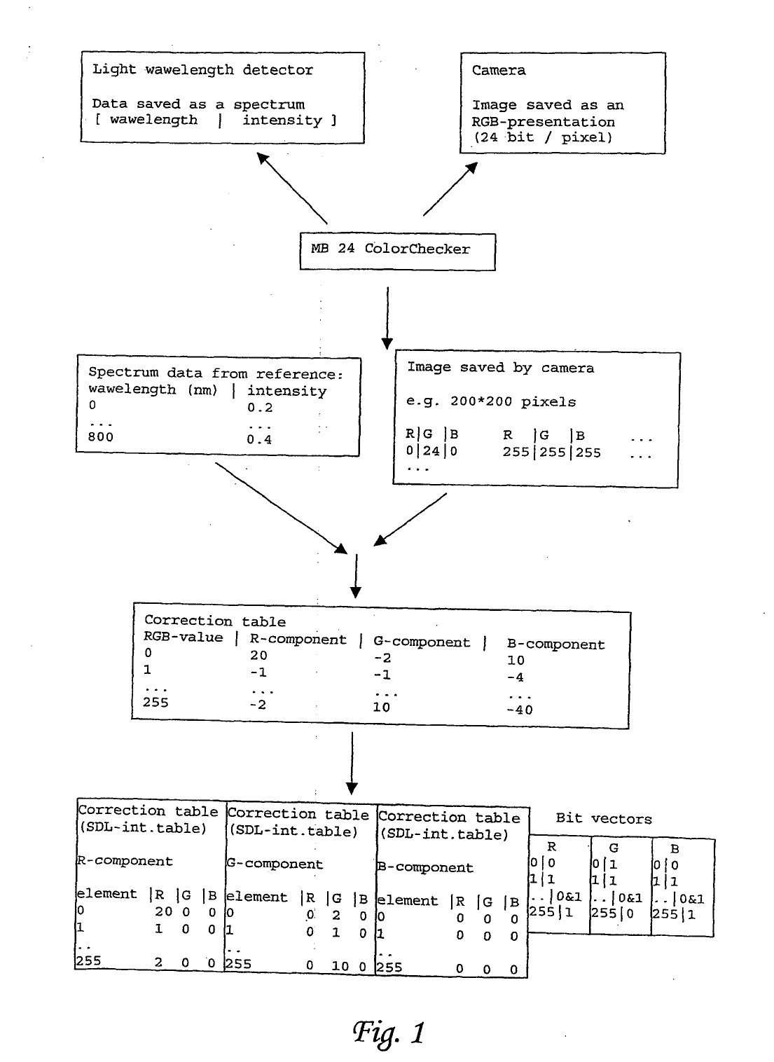

FIG. 1 illustrates a chart in principle of the colour calibration method of a camera and/or display device in accordance with the invention, and

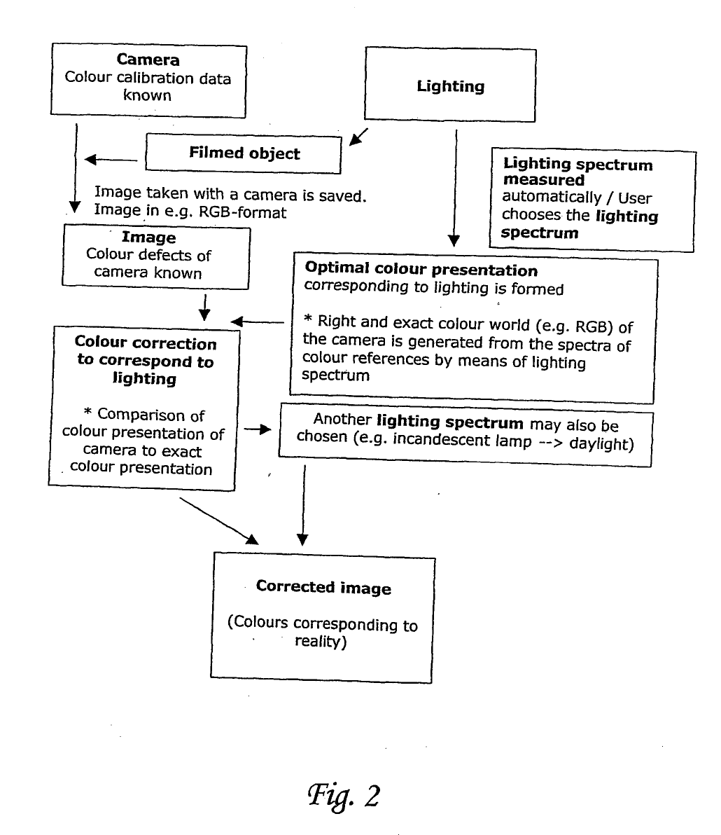

FIG. 2 illustrates a chart in principle of real time colour correction for a digital image.

In the colour calibration method of a digital camera illustrated in the diagrammatic chart in FIG. 1 the colour reference is taken with a camera, which is to be colour calibrated. In this case, colour references are formed from the MB 24 Color-Checker-table, which has 24 different colours. A camera forms a 24-bit RGB colour presentation of the image taken of an object. The RGB colour presentation formed by the camera is a table, which has colour values corresponding to values 0-255 of colour components R, G and B, which has been formed by the sensor of the camera. For colour calibration, the spectra of colour references are formed from the colour references with a wavelength detector of light or the earlier measured spectra from colour references are used. In addition, the spectrum of lighting is measured in lighting at the moment of photographing the colour references. Measuring of the spectrum of lighting is carried out also with a wavelength detector. By means of the spectrum of lighting, the information about how the intensity of light has been divided to various wavelengths is gained and by means of that, it is possible to correct the spectra of colour references to correspond to lighting circumstances at the moment of photographing. The RGB colour presentation of the camera and all spectrum information is transmitted to a computer for colour calibrating of the camera. The computer used may be, for example, a microcomputer or an embedded system (i.e. for example the camera system itself). As graphic-interface SDL (Simple Direct Layer) -interface is employed in the application in accordance with FIG. 1. As a saving format of image data a 32-bit saving format for image data is used, although as earlier presented the image data is read as 24-bit from a camera. The change between saving formats is realized by means of SDL-interface.

In a computer, a RGB colour presentation corresponding to the RGB colour presentation of a camera by format is created from the spectra of colour references and the spectra of lighting by multiplying the spectrum of colour references by the spectrum of lighting. The RGB colour presentation formed of the spectrum information of colour references is a table reminding a RGB colour presentation of a camera, in which table there are colour values corresponding to elements 0-255 of colour components R, G and B. After this, a system function (correction table) of RGB colour presentation of a camera is calculated from the RGB colour presentation formed of the RGB colour presentation of the camera and the spectrum information. The values of the correction table are also saved as 32-bit RGB colour presentation to a table with the form as earlier presented. The final colour calibration itself of RGB colour presentation of a camera is carried out by adding RGB colour values (correction table values) of the system function to RGB values of a camera. While facilitating the SDL-interface a bit vector has to be formed from the negative values of the table as presented in the chart in FIG. 1. By this, an overflow in the SDL-interface is prevented. After adding the correction table, the camera forms a RGB colour presentation from the image data formed by a sensor, which RGB colour presentation corresponds to the colour presentation measured with a wavelength detector of light from colour references under circumstances at the moment of photographing. This kind of colour calibration takes into account individual defects (for example deviation on certain wavelengths/wavelength ranges) taking place in image forming devices of a camera and as the result gives the (right) colour presentation very exact corresponding to the colour presentation received from the spectrum information. In addition, this kind of colour calibration of a camera always takes into account the influence of lighting due to which the colour presentation formed with a camera corresponds to a colour presentation of colour references seen by the eye better than with cameras calibrated with method known earlier in spite of lighting circumstances.

Colour calibration of a display device facilitating RGB colour presentation is principally carried out in a way corresponding to the colour calibration of a camera by first defining a system function to the RGB colour presentation of the display device by means of the RGB colour presentation of colour references formed by the display device and the RGB presentation of colour references formed from the spectrum information. The RGB colour presentation formed by the display device is found out, for example, by measuring colours of the display device with a chromameter or with a wavelength detector of light and forming a RGB colour presentation of the display device in table form from a three-value colour presentation received as a measuring result. As the spectra of colour references earlier from colour references measured spectra may be facilitated (often ready measured spectra of colour references in certain lighting have been delivered with the colour references), in which case it is not necessary to measure the spectra of colour references again. The spectrum of lighting is measured with a wavelength detector of light and the spectra of colour references are corrected to correspond to lighting circumstances at the moment of calibration as earlier presented by subtracting the spectra of colour references by the spectrum of lighting. A system function (correction table) of the RGB colour presentation of a display device is formed of the RGB colour presentation of colour references formed by the display device and from the RGB presentation of colour references formed from the spectrum information. Colours of a display device are calibrated by multiplying the colour values of the correction table to the colour values of the RGB colour presentation formed by the display device, in which case the colour presentation formed by the display device corresponds to the exact colour presentation of colour references formed from the spectrum information.

Frequently it is advantageous that a camera and a display device are colour calibrated at the same time. In this way, it is possible to have the colours in the picture taken with a camera to look as exactly as possible the same while presented in the display device as in nature. For example, the filmed colours of colour references are, in this case, of the same colour on the display as in nature regardless of lighting circumstances. The same spectra of colour references formed from the spectrum information and the measured spectra of lighting may be utilized in simultaneous colour calibration of a camera and a display device. Therefore, only the RGB colour presentation produced by a display device needs to be measured separately, while the RGB colour presentation of a camera is formed automatically at the moment of photographing the colour references.

FIG. 2 presents a chart in principle of real-time colour correction for a digital image. Colour correction is carried out with a colour calibrated camera or a display device. Colour calibration is accomplished, for example, in accordance with the principle of FIG. 1. In correction, the exact RGB values are formed from the colour spectra of colour references as well as from the lighting spectrum. The method is not limited to RGB values only, but it may be applied to any other colour spaces with three or more components. This colour calibration information enables the real-time accomplishment of colour correction to correspond to lighting. The same method is applied to display devices but the spectral reproduction is measured, for example, with a radiometer from a display device.

Colour correction of a digital camera or a display device starts with measuring of the spectrum of lighting or choosing the spectrum of lighting from a database. The spectrum of lighting may also be measured exactly or only certain characteristics of it may be measured on which grounds the spectrum may be identified. The spectrum of lighting may also be identified based on the colour information or content of an image. By means of the spectrum of lighting the exact and as right as possible colour world is generated, for example, to the traditional RGB colour space under existing photographing circumstances. The optimal colour space is created by combining the spectrum of lighting to the spectra of colour references received as the result of colour calibration.

The final colour correction is carried out by editing the colour calibrated image data of a camera or a display device to correspond to the exact colour values generated in accordance with desired lighting. In colour correction, also individual colour defects of a camera or a display device are taken into account on grounds of colour calibration data of a camera or a display device. Colour defects received as the result of calibration have been saved as values of RGB colour space, for example, in which case from the colour space created on grounds of lighting, the RGB values are subtracted or added, in accordance with the colour calibration data of a camera or a display device. In RGB colour space tables, corresponding to 0-255 values to each component are formed, in which tables changes corresponding to each value have been presented. On grounds of these changes, the correction of image data is realized, for example, by subtracting the correction values from the original RGB image data. The method may, while necessary, be utilized to edit a digital image to correspond to different lighting circumstance, which may differ from the lighting at the moment of photographing, for example, a picture taken in incandescent lighting may be changed to correspond to daylight circumstance. In this case, a spectrum of lighting chosen by the user, for example, is employed as the spectrum of lighting.

The method and the device in accordance with the invention for colour calibration or correction of a camera and/or a display device may be realized in many various ways differing from the example applications presented earlier. The method may also be realized in other colour spaces than in the RGB colour space. The method may be applied, for example, in RGBE, RGBA, CMYK, YUV, YIQ, HSV and corresponding colour spaces consisting of various components. In addition, the method may be applied for colour calibration and correction of a spectrum camera as well as in presentation of spectrum images in earlier mentioned colour spaces. Furthermore, various stages of the method may be realized in many different ways. Calibration and correction may be accomplished also by comparing colour references to be presented in a display device or photographed colour references with corresponding physical colour references and by adjusting the colour presentation of a display device and a camera to correspond to colour presentations of physical colour references visible for the human eye. This may be realized by adjusting with a programme the spectrum of light and calculating new RGB presentations from spectra of colour references by means of earlier mentioned spectrum of lighting. Furthermore, for example, measuring of spectra of colour references may be accomplished with various devices/methods suitable for measuring a spectrum. For example, a radiometer may be employed as a wavelength detector and light may be dispersed into a spectrum with many currently known ways, such as with a prism, a grating or with various colour filters, before measuring the intensity of its different wavelengths with a semiconductor detector. In many cases, measuring the spectrum of colour references is not necessary as they are measured earlier. In such cases only the spectrum of lighting must be defined, with which the RGB colour presentation of colour references formed of the spectrum information may be made to correspond to lighting circumstances existing at the moment of photographing.

1. A method for colour calibrating a camera and/or a display device and for correcting colour defects from digital images, in which method
a digital image formed with a camera and/or a display device is adjusted by correcting colour values of the digital image of the camera and/or the display device,
the digital image formed/produced with a camera and/or a display device is corrected by means of a database formed of spectrum information of colour references,
and in the colour presentation of the database formed from the spectrum information of colour references the influence of lightning is taken into account by means of the spectrum of lightning.

2. A method in accordance with claim 1, in which
the colour presentation of the database formed from spectrum information of colour references is calculated from the spectra of colour references and the spectrum of lighting by combining the spectrum of lighting with the spectra of colour references.

3. A method in accordance with claim 1, in which
while lighting changes the colour presentation database formed from the spectrum information of colour references is calculated again by combining the spectra of colour references with the spectrum of changed lighting.

4. A method in accordance with claim 1, in which
the spectra of colour references and/or the spectrum of lighting corresponding to lighting circumstances at the moment of photographing are measured with a wavelength detector of light.

5. A method in accordance with claim 1, in which
a colour space composed of components is employed,
and the database calculated from the spectrum information of colour references is employed for adjusting the colour space formed of components.

6. A method in accordance with claim 5, in which
from a database formed from the spectrum information of colour references a system function of a camera and/or a display device is formed by subtracting from the colour values formed of the components of the camera and/or a display device the colour values of the colour presentation formed from the components of the spectrum information of colour references and that by means of the system function the corrected, out of components formed colour presentation of a camera and/or a display device is defined.

7. A method in accordance with claim 6, in which
the corrected, out of components formed colour presentation of a camera and/or a display device is formed by adding the colour values formed from the components of the system function to the colour values formed from the components of the colour presentation of a camera and/or a display device.

8. A method in accordance with claim 7, in which
the RGB colour presentation is employed as the colour presentation formed from components.

9. A device for colour calibrating a camera and/or a display device and for correcting colour defects from digital images, which device comprises
an equipment for adjusting the digital image formed with a camera and/or a display device by correcting the colour values of the digital image of the camera and/or the display device,
an equipment for correcting the digital image formed/produced with a camera and/or a display device by means of a database formed from the spectrum information of colour references.
